(19) United States
(12) Patent Application Publication
(10) Pub. No.: US 2002/0002032 A1
(43) Pub. Date: Jan. 3, 2002

(54) User customized radio

(76) Inventor: Michael D. Fleenor, La Mirada, CA (US)

Correspondence Address: Rodger H. Flagg, Patent Agent, c/o EXPRESS SEARCH INC., 2121 Eisenhower Ave, Suite 500, Alexandria, VA, 22314, US

(21) Appl. No.: 09/884,934

(22) Filed: Jun. 21, 2001

Related U.S. Application Data
(60) Provisional application No. 60/212,831, filed on Jun. 21, 2000.

(51) Int. Cl. H04H 1/00

(52) U.S. Cl. 455/3.03; 455/3.01; 455/3.04

(57) ABSTRACT

A system provides user customized radio (UCR) services, and can provide a subscription-based service that allows a user to select subject matter they wish to hear about on their radios. The system is especially suited for use with digital radio receivers. The system includes features by which each user of the system is able to select from categories of information broadcast to an “intelligent” radio receiver. The specific categories and topics selected result in a customized broadcast where the user receives audio text that match their stored profile from a database of thousands of stories updated daily. This system would require the user to obtain a Digital Radio Receiver (DRR). The UCR system broadcasts the collective stories as broadcast information, that all users have requested. Each DRR searches the broadcast for broadcast information that match its user's requested profile. This service can be targeted at commuter markets, and in that case secondary markets will include portable radio, computer, office and home use.

This utility patent application claims priority of a U.S. provisional patent application, Ser. No. 60/212831 filed Jun. 21, 2000, and said provisional patent application is hereby incorporated by reference herein.

### FIELD OF THE INVENTION

The present invention relates to user customized radio services and supporting system, which can provide a subscription-based service that allows a user to select subject matter they wish to hear about on their radios, and specifically for digital radio receivers.

### BACKGROUND OF THE INVENTION

For purposes of this disclosure:

DDR is used to represent a digital radio receiver;

UCR is used to represent a user customized radio; and

USP is used to represent user service profile(s).

The technology for digital radio is becoming highly developed, and there is also known technology for selecting files of various types (video, audio, internet, etc.) on demand.

U.S. Pat. No. 5,406,634 depicts a centralized control public address system of remote speakers. In this patent, an intelligent speaker unit is able to select channels from a stream of digital audio data. The audio data can be stored or saved. There is no localized control of what is received at each speaker.

U.S. Pat. No. 5,726,909 teaches a library based system with centralized control for background music.

U.S. Pat. No. 5,809,246 discloses a library based system with centralized control for optimizing operation of a radio station.

U.S. Pat. No. 5,732,324 teaches a specific transmission technique for providing burst data to passing vehicles. It mentions that the content is geographically tailored to the location of the transmitter, and different transmitters would have different local content.

U.S. Pat. No. 5,233,663 teaches a system targeted specifically at language translation rather than a subscription based customized radio broadcast.

U.S. Pat. No. 5,944,790 teaches language translation for Internet access, rather than a subscription based customized radio broadcast.

U.S. Pat. No. 4,788,675 discloses a library based system rather than a subject matter based system.

U.S. Pat. No. 5,926,624 teaches a playback device that receives library content rather than the UCR method of subject matter content. Additionally, under the technique of this patent, the listening device receives audio files from the client computer system, while the UCR receives the digital audio files from the broadcast.

U.S. Pat. No. 5,832,223 relates to access to the Internet via a remote unit and a broadcast signal. It differs from UCR in that in UCR, a user employs the Internet to program their audio subscription service and receives that service from a DRR. In this patent, the concept of a wireless Internet is set forth in which data requests are made from the Internet Access Unit rather than a request for subject matter (as under UCR). Under UCR, the content that is provided by the service is not necessarily retrieved from the Internet.

U.S. Pat. No. 5,303,393 teaches an audio satellite digital broadcast, but with no customization by the user. There is no mention of the UCR concept wherein a DRR would buffer different news stories into virtual channels selected by the user.

U.S. Pat. No. 5,455,823 teaches a specific radio implementation method as mentioned in previous U.S. Pat. No. 5,303,393. This, however, is not similar to a model such as UCR.

U.S. Pat. No. 5,557,541 teaches a technique of downloading library-based audio files from a network to a portable audio storage and retrieval device. This differs from a UCR subscription-based broadcast of user specified subject matter.

U.S. Pat. No. 5,440,336 discloses technology associated with library based video/audio-on-demand. This technology can be similar to the technology employed in DRR. This technology is targeted at hotel/home video-on-demand rather than a customized audio broadcast.

U.S. Pat. No. 5,949,492 teaches technology wherein an end user can request more information about audio/visual content received via television or radio. Although this capability may be integrated into UCR, it does not encompass the UCR business model of a subscription based selection of subject matter to be received from a broadcast signal.

U.S. Pat. No. 5,673,401 relates to a method to interact and order products on television. It uses a set top box as a part of the user interface, and illustrates the use of a remote control to operate the system to which it is specific.

U.S. Pat. No. 5,682,511 relates to a children's video-on-demand for a television application, but it is not computer based. A remote is for the specific purpose of interaction and ordering goods.

U.S. Pat. No. 5,929,851 teaches a DVD application for playback video-on-demand and is customized for a very specific function.

U.S. Pat. No. 5,262,875 discloses functions of servers to send information, as does U.S. Pat. No. 5,550,982 and U.S. Pat. No. 5,442,749.

U.S. Pat. No. 5,706,334 relates to Lucent Television based on demand specific technology. U.S. Pat. No. 5,745,642 relates to enhancing video stream performance. U.S. Pat. No. 5,790,794 relates to a video-on-demand system, not an operating product. U.S. Pat. No. 5,956,716 relates to a video streaming internet product with a method for delivery. The method of delivery is not switching and changing of channels, however. U.S. Pat. No. 5,884,028 teaches a method for delivering data, but not for accessing data in a simple switch.

U.S. Pat. No. 5,815,148 teaches a user interface, and is specific to a multimedia aspect. It is a video-on-demand based system.

U.S. Pat. No. 5,970,473 is directed toward a catalog-ordering system, and U.S. Pat. No. 5,973,638 is specific to a graphical user interface.

### SUMMARY OF THE INVENTION

According to the present invention, a device is provided which meets the aforementioned requirements and needs in the prior art. Specifically, the device according to the present invention provides user customized radio services and a supporting system therefor, and can provide a subscription-based service that allows a user to select subject matter they wish to hear about on their radios. The system according to the invention is especially suited for use with digital radio receivers.

These and other objects according to the present invention are accomplished by provision of a system in which each user of the system will be able to select from categories of information to be broadcast to an “intelligent” radio receiver. The specific categories and topics selected result in a customized broadcast where the user receives audio files that match their stored profile from a database of thousands of audio files updated daily. These audio files may contain news, information, or entertainment content. This system would require the user to obtain (by purchase or lease, for example) a Digital Radio Receiver (DRR). The UCR system broadcasts the collective audio text that all users have requested. Each DRR searches the broadcast for news text that match its user's requested profile. This service is targeted at the commuter market. Secondary markets include portable radio, office and home use.

User service profiles (USP's) from all users are read by a system control center. The collective requests from multiple users are considered and prioritized by popularity. The prioritized request list is then sent to a system recording studio where a bank of newscasters select text data from newswire services and read them into recording microphones. The resulting audio text is digitally stored and sent back to the system control center for distribution to the radio network. The system control center may also receive pre-recorded audio content from newswire, information, or entertainment services. When there is a lack of content for a specific user's topic request, any particular user's radio service may be augmented with related topics or categories.

Other objects and advantages of the present invention will be more readily apparent from the following detailed description when read in conjunction with the accompanying drawings.

### BRIEF DESCRIPTION OF THE DRAWINGS

FIG. 1 is a schematic diagram of an operation process of a User Customized Radio (UCR) system according to the present invention.

### DETAILED DESCRIPTION OF THE INVENTION

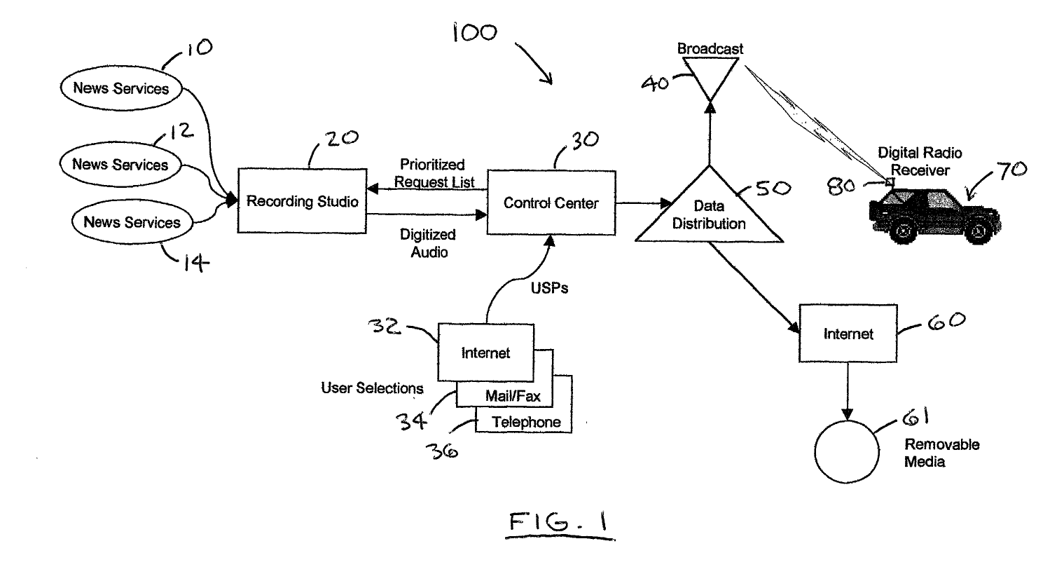

A method of providing a subscription based customized radio service is disclosed FIG. 1 and the following detailed description of the invention.

A schematic diagram is shown in FIG. 1 of an operation process of a User Customized Radio (UCR) system 100 according to the present invention. In this diagram, a recording studio 20 accesses news sources and produces digitized audio from the news sources. The news sources include various news, information and entertainment services 10, 12, and 14, and may include further sources or may include fewer sources, depending on the level desired by the broadcaster.

The recording studio 20 sends the digitized audio output to a control center 30, which in turn supplies the digitized audio output to a data distribution center 50. The data distribution center 50 includes a broadcast transmitter 40. The broadcast transmitter 40 transmits digital radio signals, which are in turn received by a digital radio receiver (DRR) 80 carried by a user or a user's vehicle 70.

The control center 30 also receives input from individual user service profiles (USP's) via any available sources, including, for example, an internet provider 32, mail or telefacsimile messages 34, or even by a telephone system 36. The data distribution center 50 also can provide an output to the subscriber's internet account 60. The internet account 32 may be the same as the internet account 60, or may differ to suit the needs of the user. The User Customized Radio (UCR) system 100 includes the capability for the user to playback the audio files on their personal computer, or download the audio files to a removable media or playback device.

The (UCR) system 100 allows customers to program their own radio service. Each user of the system will be able to select from categories of information to be broadcast to the “intelligent” radio receiver 80. The specific categories and broadcast information topics selected result in a customized broadcast where the user receives broadcast information that match their stored profile (the above-mentioned USP's) from a database (10, 12, 14) of thousands of audio files updated daily. This system requires the user to obtain (by purchase or lease, for example) the Digital Radio Receiver (DRR) 80. The UCR system 100 broadcasts a plurality of collective broadcast information that all users may have requested. Each DRR 80 searches the broadcast for broadcast information (from the services 10, 12, 14) that match its user's requested profile (from the database collected from selections 32, 34, and 36). This service is targeted at the commuter market. Secondary markets include portable radio, computer use, office use, and home use.

User service profiles (USP's) 32, 34, and 36 from all users are read by the system control center 30. The collective requests from multiple users are considered and prioritized by popularity. The prioritized request list is then sent to the system recording studio 20 where a bank of newscasters can select text stories from newswire services 10, 12, and 14, and read them into recording microphones. The resulting audio files are digitally stored and sent back to the system control center 30 for distribution 50 to the radio network 40. The system control center 30 may also receive pre-recorded audio content from news, information and entertainment services, for distribution 50 to the radio network 40.

When there is a lack of content for a specific user's topic requests, any particular user's radio service may be augmented with related topics or categories.

There are various aspects of the present invention. For example, the customized radio service represents a subscription based business model in which the user controls the subject matter via the Internet, then receives digital content via a Digital Radio Receiver. The user has control of the DRR to the point they can select channels of content that they have specifically created via their Internet account.

In one example of UCR architecture, the DRR or control device is connected to the network or client computer to accept programming commands but not actual audio content. Also, the present invention is capable of delivering web sites to the user, as well as programming and videos. And, it can navigate and search for the user.

After each story is recorded, the digitized audio file is sent to the control center 30 for broadcast. The control center integrates the story into the broadcast list, replacing older stories and keeping the broadcast updated.

The broadcast list is used to create the digital broadcast stream that is then sent to the data distribution center 50 where it is broadcast, placed on the Internet, or downloaded to stored media for playback/archiving. The use of a digital broadcast signal allows for multiple audio stories to broadcast simultaneously.

This in turn allows the Digital Radio Receiver (DRR) 80 to play one story while saving other stories in memory (or buffering). The DRR 80 is programmed with a particular USP (32, 34, 36) via a command channel on the broadcast list. The DRR 80 will select broadcast information, such as stories, from related categories and topics. As the radio downloads broadcast information, such as news text, it will save them in its internal storage buffer.

The buffering of multiple audio text allows the user to skip, pause or repeat selected audio text as desired. The DRR 80 will also allow a user to save a particular audio text to a separate memory buffer (not shown) where it will not expire until it is deleted. As the user develops their individualized USP, they can assign each category or topic selected to a virtual channel. The number of channels, as well as how they are controlled, is therefore completely up to the user. This significantly separates UCR from other known types of digital radio broadcast services.

In the present invention, the user receives the specific broadcast information they wish to hear, and has preprogrammed their preferences into the customized channels that they have defined, as discussed herein.

The audio text may include pre-recorded or live audio content from various information sources, which may be selectively integrated into a selected user customized radio broadcast.

The invention being thus described, it will be evident that the same may be varied in many ways. Such variations are not to be regarded as a departure from the spirit and scope of the invention and all such modifications are intended to be included within the scope of the claims.

I claim:

1. A method of providing a subscription based customized radio service, which comprises:
a) Subscribing to a user customized radio broadcast information system;
b) selecting at least one category of broadcast information from multiple categories of broadcast information available upon said user customized radio broadcast information system;
c) receiving said selected category of broadcast information from said user customized radio broadcast system, and playing said selected category of broadcast information upon a selected user's digital radio receiver; and
d) periodically updating said multiple categories within said user customized radio broadcast information system, to provide a customized radio service featuring said user selected categories of broadcast information, to the exclusion of other unselected categories of broadcast information.

2. The method of providing a subscription based customized radio service of claim 1, wherein the multiple categories within said user customized radio broadcast information system are updated at least daily.

3. The method of providing a subscription based customized radio service of claim 1, wherein a subscription fee is paid for access to said selected category of the user customized radio broadcast information system.

4. The method of providing a subscription based customized radio service of claim 1, wherein the digital radio receiver searches said multiple categories of broadcast information for data that matches the selected category of broadcast information, and the selected category of broadcast information is played by the selected user's digital radio receiver.

5. The method of providing a subscription based customized radio service of claim 1, wherein a system control center prioritizes the collective requests from multiple users, and newscasters select news, information and entertainment services responsive to selected categories from one or more newswire services, and said newscasters read the selected news, information and entertainment services into recording microphones, and the selected audio files are then digitally stored, and sent to the system control center for distribution over the customized radio network.

6. The method of providing a subscription based customized radio service of claim 1, wherein the selected audio files are sent by a digital broadcast transmitter for receipt by a digital radio receiver.

7. The method of providing a subscription based customized radio service of claim 1, wherein the user may selectively record the customized audio messages, for later playback on a suitable playback device.

8. A method of providing a subscription based customized radio service, which comprises:
a) Subscribing to a user customized radio broadcast information system;
b) selecting at least one category of broadcast information from multiple categories of broadcast information available upon said user customized radio broadcast information system;
c) receiving said selected category of broadcast information from said user customized radio broadcast system, and playing said selected category of broadcast information upon a selected user's digital radio receiver;
d) periodically updating said multiple categories within said user customized radio broadcast information system, to provide a customized radio service featuring said user selected categories of broadcast information, to the exclusion of other unselected categories of broadcast information;
e) e) prioritizing the collective requests from multiple users, and selecting text files responsive to selected categories of text files from one or more newswire services, and reading the selected text files into recording microphones, and digitally storing the selected audio files, then distributing multiple selected audio files over the customized radio network; and
f) selectively integrating pre-recorded and live audio content from other information sources into the user customized radio network.

9. The method of providing a subscription based customized radio service of claim 8, wherein the multiple categories within said user customized radio broadcast information system are updated at least daily.

10. The method of providing a subscription based customized radio service of claim 8, wherein a subscription fee is paid for access to said selected category of the user customized radio broadcast information system.

11. The method of providing a subscription based customized radio service of claim 8, wherein the digital radio receiver searches said multiple categories of broadcast information for data that matches the selected category of broadcast information from multiple catagories of broadcast information provided by the customized radio service, and the selected category of broadcast information is played by the selected user's digital radio receiver.

12. The method of providing a subscription based customized radio service of claim 8, wherein a plurality of newscasters select text stories responsive to selected categories from one or more newswire services, and said newscasters read the selected text stories into recording microphones as broadcast information, for distribution over the customized radio network.

13. The method of providing a subscription based customized radio service of claim 8, wherein the selected audio files are sent by a digital broadcast transmitter for receipt by a digital radio receiver.

14. The method of providing a subscription based customized radio service of claim 8, wherein the user may selectively record the customized audio messages, for later playback on a suitable playback device.

15. The method of providing a subscription based customized radio service of claim 8, wherein a central control center digitizes the selected customized audio messages, stores the selected customized audio messages, and broadcasts the selected customized audio messages for receipt by a user in accordance with their selected category of broadcast information.

16. The method of providing a subscription based customized radio service of claim 8, wherein multiple audio files are broadcast simultaneously, and the digital radio receiver plays one broadcast information file, while saving other broadcast information files in a digital memory buffer.

17. A method of providing a subscription based customized radio service, which comprises:
a) Subscribing to a user customized radio broadcast information system;
b) selecting at least one category of broadcast information from multiple categories of broadcast information available upon said user customized radio broadcast information system;
c) receiving said selected category of broadcast information from said user customized radio broadcast system, and playing said selected category of broadcast information upon a selected user's digital radio receiver;
d) periodically updating said multiple categories within said user customized radio broadcast information system, to provide a customized radio service featuring said user selected categories of broadcast information, to the exclusion of other unselected categories of broadcast information;
e) prioritizing the collective requests from multiple users to selectively provide said broadcast information;
f) selecting text files responsive to selected categories from one or more newswire services and integrated audio services, and digitally recording said text stories as broadcast information in said selected categories, and digitally storing the selected broadcast information;
g) distributing multiple selected broadcast information over the customized radio network;
j) broadcasting multiple broadcast information simultaneously over the customized radio network, and the digital radio receiver plays one story while saving other stories in a digital memory buffer.

18. The method of providing a subscription based customized radio service of claim 17, wherein a plurality of newscasters select text files responsive to selected categories from one or more newswire services, and said newscasters read the selected text files into recording microphones to provide broadcast information, for subsequent distribution over the customized radio network.

19. The method of providing a subscription based customized radio service of claim 17, wherein the user may selectively record the customized audio messages, for later playback on a suitable playback device.

20. The method of providing a subscription based customized radio service of claim 17, wherein pre-recorded and live audio content from various information sources are integrated into portions of the user customized radio broadcast.
